(19) United States
(12) Patent Application Publication
(10) Pub. No.: US 2007/0129969 A1
(43) Pub. Date: Jun. 7, 2007

(54) METHODS AND APPARATUS FOR A MEDICAL DATA ENTRY SYSTEM

(75) Inventors: Kevin D. Burdick, Salt Lake City, UT (US); D. Bruce Bogdan, Salt Lake City, UT (US)

Correspondence Address: SNELL & WILMER L.L.P. (Main), 400 EAST VAN BUREN, ONE ARIZONA CENTER, PHOENIX, AZ, 85004-2202, US

(73) Assignee: INVESTMED, L.L.C., Salt Lake City, UT (US)

(21) Appl. No.: 11/469,165

(22) Filed: Aug. 31, 2006

Related U.S. Application Data
(60) Provisional application No. 60/596,101, filed on Aug. 31, 2005.

(51) Int. Cl. G06F 19/00

(52) U.S. Cl. 705/3

(57) ABSTRACT

An efficient system for entry of patient information for use by a medical office, the system including a patient data entry system and an administration system for converting the patient information for use in medical office management systems. Patient data entry may also be performed remotely over the Internet. By accepting direct electronic data input from patients through an in-office data entry system or through a web-based data entry system, transcription errors are prevented and office staff efficiency is increased.

### CROSS-REFERENCE TO RELATED APPLICATIONS

The present application is related to U.S. provisional application Ser. No. 60/596,101, filed Aug. 31, 2005, which is incorporated by reference as if fully set forth herein.

### FIELD OF INVENTION

The present invention relates generally to a system and method for the efficient administration of medical offices and patient records. More particularly, the invention relates to networked software applications for entry and management of patient data.

### BACKGROUND OF THE INVENTION

Existing methods of gathering patient data typically involve a patient filling out various paper forms, a medical staff member verifying the correctness and completeness of the information, and manually entering the data into a medical office management system. The conventional handling of patient data is cumbersome, expensive, prone to errors, and requires significant medical staff time for verification and entry of data into the medical office management system. Additionally, patient information may be collected from the patient that may not be accepted by the medical office management system; thereby decreasing access to patient data because it exists in paper form only. Furthermore, patient information is not easily transferred from one medical office or practitioner to another. The delay and potential for error inherent in such conventional data entry and management systems often results in unnecessary delay for patients and care providers alike. Paper systems are inherently prone to many types of errors, for example, omitted or inaccurate medication records could be potentially life threatening.

Thus, a need exists for a system and method for increasing the reliability, portability, and accessibility of patient data while reducing the time required for medical staff to verify and enter patient data into a medical office management system.

### SUMMARY OF THE INVENTION

The invention comprises a medical data entry system including a patient data entry system for entering information into a patient information record and an administration data entry system for receiving or retrieving the patient information record. The system further includes features for verifying that the information is correct and complete, for converting the data from the patient information record into a format usable by a medical office management system, and for merging or importing the data into the patient management system. In various embodiments, the data entry system is a computer kiosk or a portable computer available to patients in a medical office waiting room. Alternatively, the patient's own home computer may serve as the patient data entry system connected to the administration data entry system via the Internet.

In an exemplary method, a patient is requested to provide certain information at a medical office kiosk, portable computer, or web page. The patient information is received by a data entry system and is then accessed or retrieved by an administration system. The data entry system or administration system verifies the submitted information and the administration system then formats the information for storage or use by a medical office management system or patient record management system. By receiving direct electronic data input from patients and automatically importing the data into various data management systems, transcription errors are prevented and office staff efficiency is increased.

### BRIEF DESCRIPTION OF THE DRAWINGS

A more complete understanding of the present invention may be derived by referring to the detailed description when considered in connection with the Figures, wherein like reference numbers refer to similar elements throughout the Figures, and:

FIG. 1 is a block diagram of a medical data entry system with a centrally located patient information database in accordance with one embodiment of the present invention;

FIG. 2 is a flow chart of an exemplary data entry workflow in accordance with an exemplary embodiment of the present invention;

FIG. 3 is an exemplary fillable patient information record listing various demographic and billing data according to one embodiment of the present invention;

FIG. 4 is an exemplary fillable patient information record listing various medical history data according to one embodiment of the present invention; and

FIG. 5 is an exemplary fillable patient information record according to a web-based embodiment of the present invention.

### DETAILED DESCRIPTION

The detailed description of exemplary embodiments of the invention herein makes reference to the accompanying drawings, which show the exemplary embodiment by way of illustration and its best mode. While these exemplary embodiments are described in sufficient detail to enable those skilled in the art to practice the invention, other embodiments may be realized and logical and other changes may be made without departing from the spirit and scope of the invention. Thus, the detailed description herein is presented for purposes of illustration only and not of limitation. For the sake of brevity, conventional data networking, application development and other functional embodiments of the systems (and components of the individual operating components of the systems) may not be described in detail herein.

Furthermore, the component positions shown in the various figures contained herein are intended to represent exemplary functional relationships and/or physical couplings between the various elements. It should be noted that many alternative or additional functional relationships or physical connections may be present in a practical system.

Medical Data Entry System

The invention comprises, generally, a medical data entry system enabling a patient to directly input patient data into various electronic medical office forms and enabling an administrator to verify and import inputted data into a patient/office management system. One embodiment includes a patient data entry terminal for accepting patient entered information and a separate administrator terminal for verifying the information and preparing the information for use by other applications or systems such as, for example, a patient management system or medical office management system. For example, a patient kiosk or patient portable computer may be provided in a medical waiting room for automated check in and direct entry of patient information without paper forms or the need for intervention by office staff. Patient data may be populated into numerous forms, eliminating redundancy of effort for the patient and office staff alike.

In another embodiment, the system includes separate patient and administrator modules loaded on a single computer. For example, a portable computer such as a notebook computer or PDA having a patient mode or module and an administrator mode or module that allow administrators to limit the notebook applications and connectivity to data entry within designated forms in patient mode, and to restore full access and connectivity for data retrieval by office staff in an administrator mode.

In yet another embodiment, a patient data entry module may be provided within an internet accessible webpage, enabling patients to submit required information in advance of an appointment, further reducing check-in and wait times. Thus, it should be understood that any number of suitable means of providing for direct electronic data entry by a patient for use by medical staff may be implemented within the scope of the present invention.

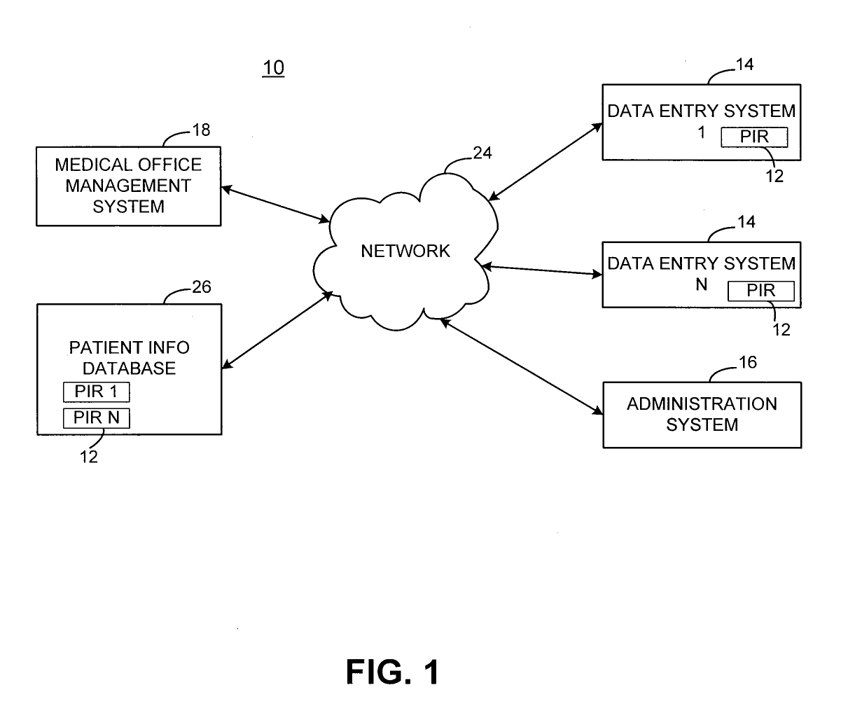

With reference to FIG. 1, an exemplary medical data entry system 10 according to one embodiment comprises one or more data entry systems 14 configured to accept patient inputted information and to populate one or more patient information records 12 (“PIR”) with the inputted patient information. For example, any information input into one form may be used to populate fields in any number of other forms or to populate database fields for reference by any number of fillable forms or applications. System 10 further includes an administration system 16 interfacing with data entry system 14 to receive the patient information records 12. At least one of data entry system 14 and administration system 16 is configured to facilitate verification of the completeness, formatting, and/or correctness of the information stored in patient information record 12.

Verification may be automatic, for example, with a module for identifying improperly formatted or incomplete demographic information, such as date or social security fields requiring a certain format and number of characters. Alternatively, verification may be carried out manually by medical staff personnel against independent patient information or through third-party verification services. Thus, verification of patient information may be performed automatically or manually using data entry system 14, administration system 16 or an office management system 18.

Administration system 16 may further interface with a medical office management system 18 to populate fields in various other medical software applications. Administration system 16 may also export patient data to a portable file or to an external device such as an optional printer. Similarly, administration system 16 may include or communicate with a fax server to receive patient data. Paper documents may be scanned into any number of formats and associated with a patient information record 12. For example, completed patient intake paperwork may be placed in a scanner and converted into PDF, JPEG, or other file formats. Any number of documents may be associated in any suitable format with patient information record 12. For example, documents may be stored as images or may be scanned for text recognition and the text may then be used to populate patient information record 12 or otherwise suitably associated with patient information record 12.

Medical data entry system 10 may include a patient information database 26 accessible by data entry systems 14 over a network 24. Database 26 receives and stores patient information records 12 for access by administration system 16 over network 24. Administration system 16 queries database 26 over network 24 for a designated patient information record 12. Administration system 16 receives and configures information from database 26 for use by medical office management system 18. Assessment of completeness and verification of correctness of the information in patient information records 12 may be performed at data entry systems 14, database 26, and/or data entry administration system 16. In alternative embodiments, database 26 may be hosted on any of the other system components described herein.

Patient Information Record

Patient information record 12 may contain any information desired for a particular application. For example, patient information record 12 may contain fields for a patient's name, birthday, various demographic data, contact information, physical feature or characteristic information, medical history, medical images, financial information, insurance information, health care agent information, medicinal compatibility information, prescriptions, known allergies and the like. In accordance with one exemplary embodiment of the present invention, patient information record fields are specific to a given medical practice, with practice specific data fields, for example, for optometrists, dentists, surgical specialists, x-ray technicians, physical therapists, and the like.

Patient information record 12 may be generated by scanning a paper document or an identification card or by other suitable hardware and/or software means. The information in patient information record 12 may be represented in any format, for example, binary, hexadecimal, ASCII, run length encoded sequences, and encrypted characters. Patient information record 12 may be stored in any form such as, for example, a computer programming language data structure, a tree structure, a linked list, a heap, a scatter-gather structure, and the like. Patient information record 12 may be stored in any suitable medium, for example, in RAM memory, Flash memory, hard disk drive memory, moveable nanostructures, light pulses, or punch cards.

Data Entry System

Data entry system 14 accepts patient information and populates the patient information record 12. Data entry system 14 may be any system configured to accept patient information. For example, data entry system 14 may be a personal computer, a key pad, a touch screen, a stylus pad, key board, a smart card reader, a magnetic card swipe reader, a scanner, a bar code reader, or the like. Data entry system 14 may populate patient information record 12 in any manner, for example, by converting information to a desired format before storing, storing separate fields of information sequentially, storing separate fields of information randomly, or holding data in temporary memory until the record is complete then writing the entire patient information record 12. A patient information summary screen may be generated for confirmation of the entered data prior to storing the entire patient information record 12.

The data entry process may be made user friendly by using completion prompting, spell checking, accepting information from the magnetic stripe of an insurance card, accepting data transferred from a smart card, accepting data from a web based e-wallet or similar service that stores and sources personal information. Data entry system 14 may interface with administration system 16 in any manner suitable for a given application. For example, data entry system 14 may be a remote patient terminal and administration system 16 may be a host server accessible to data entry system 14 over network 24. Alternatively, data entry system 14 and administration system 16 may be software subroutines executed on the same computer and may communicate by way of software messages. Additionally, data entry system 14 may interface with or be networked to administration system 16 by a direct connection, intranet, internet, World Wide Web, RF connection, infrared connection or optical connection.

In one embodiment, data entry system 14 is a personal computer. Information requests or fillable data fields are presented on the computer monitor and a patient enters information using the keyboard. The computer processor accepts information entered by the patient, optionally performs information format checking, and stores the information in a data structure in memory. Data entry system 14 may be associated with a patient information database 26 for storing multiple patient information records 12. Database 26 may be local to data entry system 14 or may be remotely hosted on a server or other networked computer.

In various other embodiments, data entry system 14 includes a magnetic card swipe reader, smart card reader, transponder reader, signature capture device, dictation input device, speech recognition or call center technology. Thus, the patient may enter information using any number or combination electronic input devices or technologies to provide required information.

Administration System

Administration system 16 is any system suitable to facilitate importation of patient information from data entry system 14 to an office management system 18. Administration system 16 may include or interface with any number of applications that process patient information record 12. For example, administration system 16 may provide information to medical office management system 18 to automatically call in or print out a patient prescription or to track patient x-rays or data supplied to a medical specialist.

Administration system 16 may include or interact with any number of applications or third-party products. For example, administration system 16 may include drivers such as Microsoft® Open Database Connectivity (“ODBC”) as well as direct database connection methods available through application such as X-Link available from EZBizSoftware at <http://www.ezbizsoftware.com>, to interface various databases and office management systems 18.

Exemplary medical office management systems 18 include AltaPoint Practice Management 6.0, Medisoft Patient Accounting version 9/10, and Lytec Medical 2005.

Office Management System

Office management system 18 may be practice specific, e.g., medical, chiropractic, vision or may be a general electronic medical records system. Exemplary medical office management systems 18 include AltaPoint Practice Management 6.0, Medisoft Patient Accounting version 9/10, and Lytec Medical 2005.

Administration system 16 may format patient information record 12 or any information therefrom for use by office management system 18. Administration system 16 may retrieve and format certain demographic information to populate office management system data fields. For example, administration system 16 may retrieve a preferred or default phone number for one data field and may automatically truncate or abbreviate data for other limited fields. Office management system 18 may use information from patient information record to perform scheduling, billing, prescription, mailing and other patient management or office management operations.

Data Entry Workflow

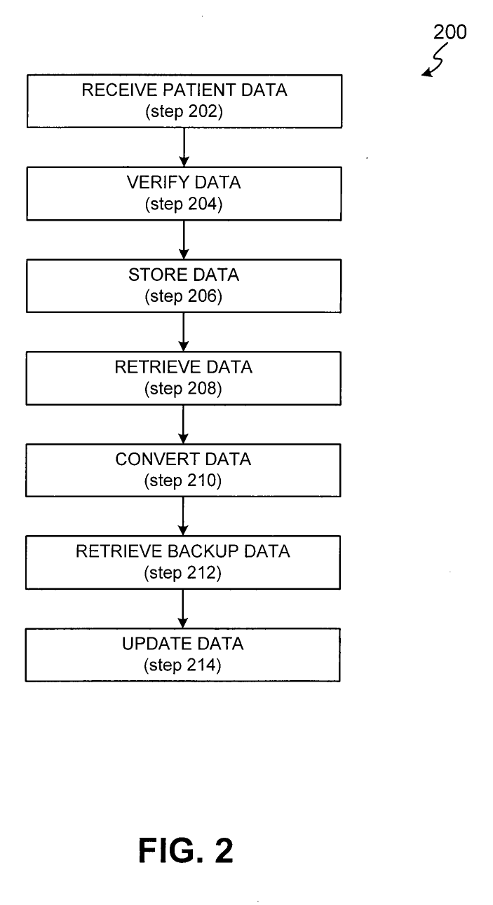

With reference to FIG. 2, an exemplary data entry workflow 200 in accordance with an exemplary embodiment of the present invention includes receiving information input by a patient at a data entry system 14 (step 202). Data entry system 14 receives patient data at a kiosk in the medical office, a webpage associated with the medical office, a patient computer terminal, PDA or the like. Patient information is then verified (step 204) prior to storage of verified data in a patient information record 12 in a database (step 206). The inputted information may be stored in a text format on the medical office network on a central server. If patient information is to be submitted to and stored on a central web server, it may be advantageous to provide practice-specific codes associated with the data files for retrieval by the respective medical practice. Administration system 16 then retrieves the patient information record 12 (step 208) and converts the data (step 210) for use by a medical office management system 1.8 or other application. Retrieval and access of patient information may be restricted based on various rights or roles assigned to any number of system users. For example, an office administrator may be granted superior access and data editing rights to those granted other office staff members.

Administration system 16 may also retrieve backup data from a remote database or server (step 212) in the event of local data loss or other system failures. Patient information records 12 may be updated (step 214) by data collected by administration system 16 from medical office management system 16 or other applications or medical service providers. For example, patient information record 12 may be updated to reflect data from a lab test, diagnosis, prescription, and the like.

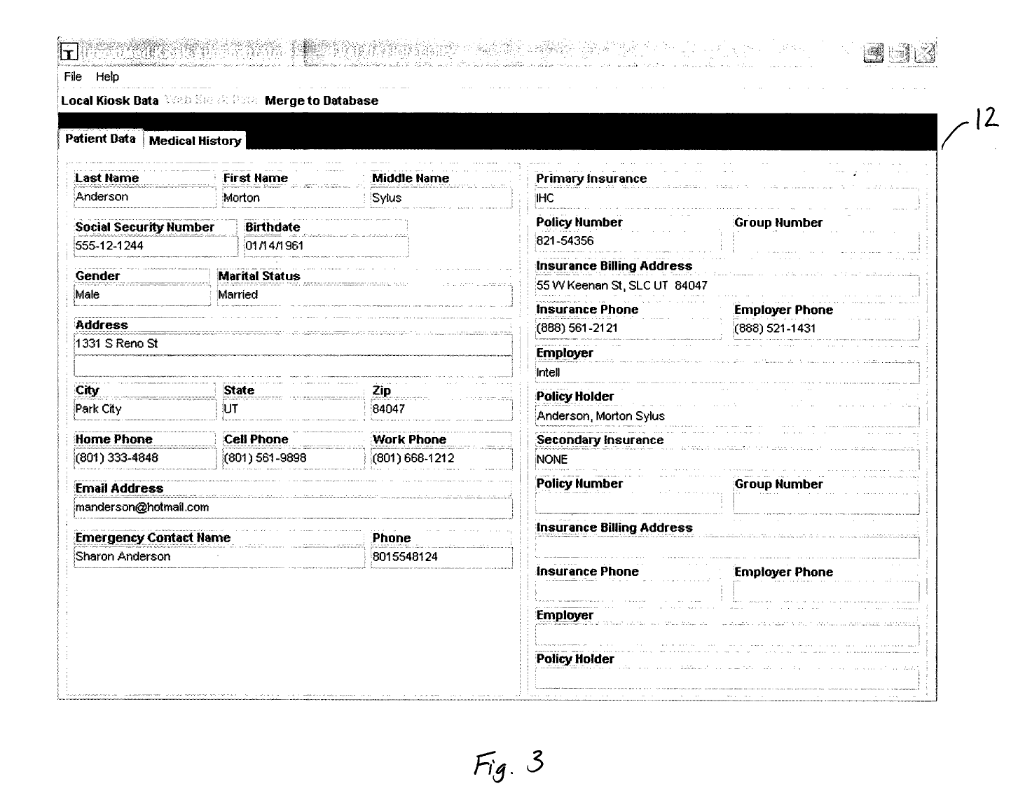

With reference to FIG. 3, an exemplary fillable patient information record 12 includes various demographic and billing data. For example, data entry system 14 may require entry of certain information such as name, address, and insurance policy information and may permit entry of additional helpful information such as marital status, email address, emergency contact and the like. The patient may submit this information through a web page, medical office kiosk, or any other suitable form of data entry system 14.

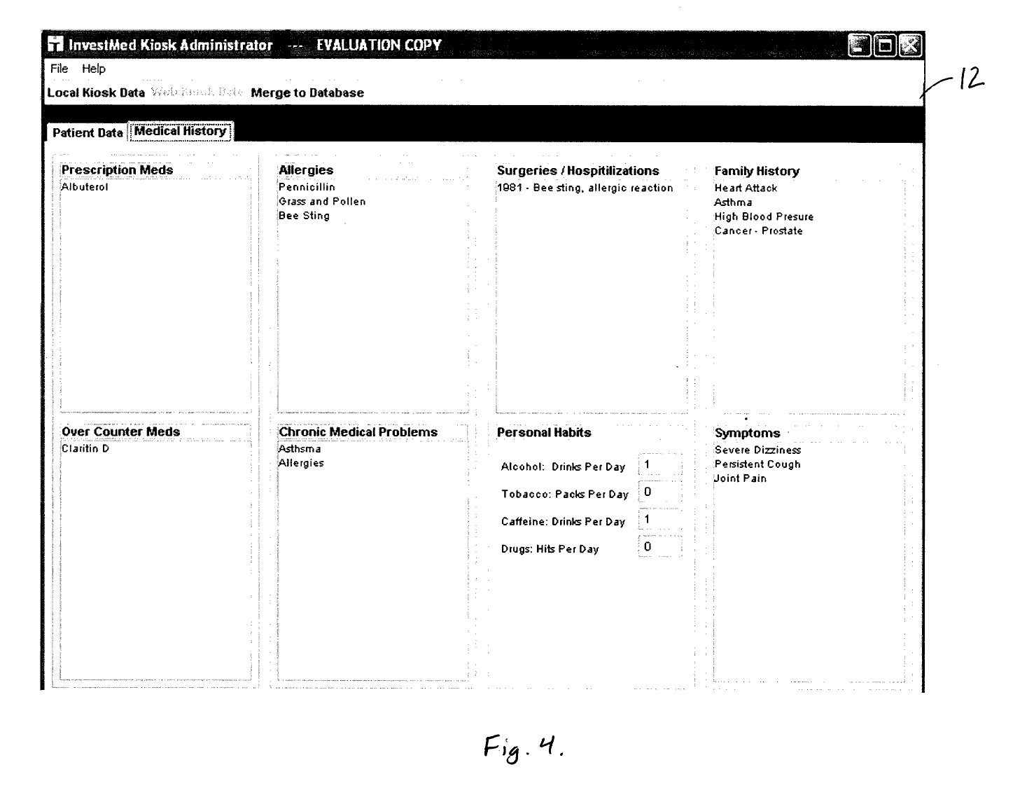

With reference to FIG. 4, an exemplary fillable patient information record 12 includes various medical history data according to one embodiment of the present invention. For example, the patient may enter any relevant information regarding prescriptions, medications, allergies, surgeries, hospitalizations, family history, chronic symptoms, personal habits, and new symptoms.

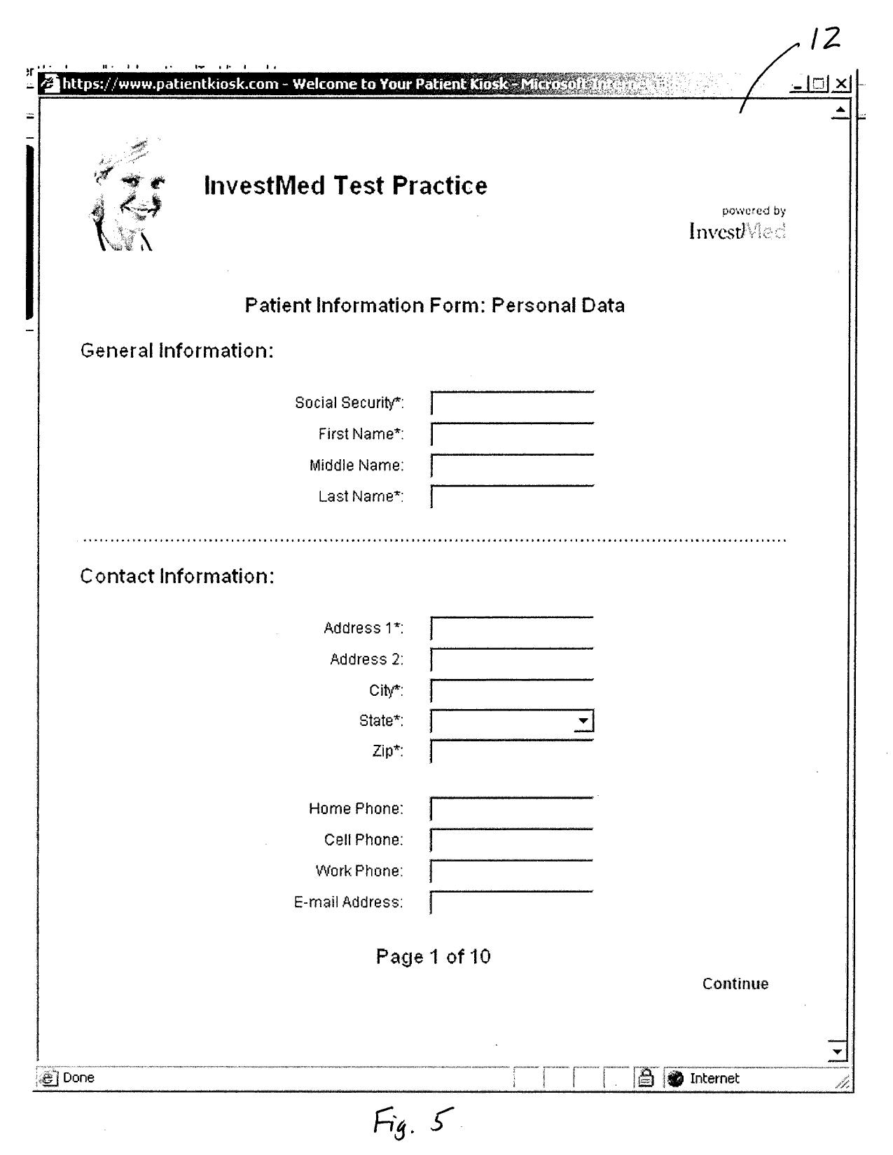

With reference to FIG. 5, an exemplary fillable patient information record 12 is accessible through a data entry system 14 webpage according to another embodiment of the present invention. Patients may access the webpage to submit or update required information in advance of an appointment, further reducing check-in and wait times. Patients may be provided a user ID and login privilege to update demographic and billing information or to provide additional medical history in anticipation of or as a follow-up to an appointment.

Administration system 16 retrieves patient information from patient information record 12, whether patient information record 12 generated using an in-office data entry system 14 or a web-based data entry system 14. Patient information record 12 or any information therein may be reformatted as needed by administration system 16 to accommodate the requirements of any given medical office management system or patient record management system. For example, in various embodiments, administration 16 may retrieve information from patient information record 12 to generate various formal documents for execution by the patient. Exemplary formal document include a do-not-resuscitate request, medical procedure authorization, information disclosure authorization, health care power of attorney, and advanced medical directive. The patient may execute the documents in paper form or may provide an electronic signature, for example using a signature capture device.

Exemplary data entry systems 14 or administration systems 16 include personal computers, laptops, notebooks, hand held computers, set-top boxes, personal digital assistants, cellular telephones, transponders or any other device suitable for receipt or delivery of electronic data. Any number of the features or steps described herein may be implemented as computer software modules loaded onto a system server or on a client computer or any computer described herein.

As will be appreciated by one of ordinary skill in the art, the present invention may be embodied as a customization of an existing system, an add-on product, upgraded software, a stand alone system, a distributed system, a method, a data processing system, a device for data processing, and/or a computer program product. Accordingly, the present invention may take the form of an entirely software embodiment, an entirely hardware embodiment, or an embodiment combining embodiments of both software and hardware. Furthermore, the present invention may take the form of a computer program product on a computer-readable storage medium having computer-readable program code embodied in the storage medium. Any suitable computer-readable storage medium may be utilized, including hard disks, CD-ROM, optical storage devices, magnetic storage devices or the like.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: patient data; medical office data; institution data; and/or like data useful in the operation of the present invention.

As those skilled in the art will appreciate, user computers may include an operating system (e.g., Windows NT, 95/98/2000, OS2, UNIX, Linux, Solaris, MacOS, etc.) as well as various conventional support software and drivers typically associated with computers. User computers may include any suitable personal computer, network computer, workstation, minicomputer, mainframe or the like. The computers may be in a home, business, or educational institution environment with access to network 24, for example, through a commercially available web-browser software package.

As used herein, the term “network” 24 shall include any electronic communications means that incorporates both hardware and software components of such. Communication between users or system components in accordance with the present invention may be accomplished through any suitable communication channels, such as, for example, a telephone network, extranet, intranet, Internet, point of interaction device, personal digital assistant, cellular phone, kiosk, online communications, satellite communications, off-line communications, wireless communications, transponder communications, local area network (LAN), wide area network (WAN), networked or linked devices, keyboard, or any other suitable communication or data input modality.

The invention may be implemented with TCP/IP communications protocols or with IPX, Appletalk, IP-6, NetBIOS, OSI or any number of existing or future protocols. If network 14 is in the nature of a public network, such as the Internet, it may be advantageous to provide firewalls, encryption, or other suitable security measures. Specific information related to the protocols, standards, and application software utilized in connection with the Internet is generally known to those skilled in the art and, as such, need not be detailed herein.

The various system components may be independently, separately or collectively coupled to network 24 via data links, which include, for example, connections to an Internet Service Provider (ISP) over a local loop as is typically used in connection with standard modem communication, cable modem, Dish networks, Digital Subscriber Line (DSL), interactive television (ITV) network or various wireless communication methods. Moreover, the system contemplates the use, access, viewing, copying, or distribution of any content, information, goods or services over any network having similar functionality described herein. Additionally, as used herein, “data” may include encompassing information such as commands, queries, files, data for storage, and the like in digital or any other form. The invention contemplates uses in association with web services, utility computing, pervasive and individualized computing, security and identity solutions, autonomic computing, mobility and wireless solutions, open source, biometrics, grid computing and/or mesh computing.

One skilled in the art will also appreciate that, for security reasons, any databases, systems, devices, servers or other components of the present invention may consist of any combination thereof at a single location or at multiple locations. Additional available security features include firewalls, access codes, encryption, decryption, data compression, and the like. Firewalls may include any hardware and/or software suitably configured to protect system components and/or enterprise computing resources from users of other networks. Further, a firewall may be configured to limit or restrict access to various systems and components behind the firewall for web clients connecting through a web server. Firewalls may reside in varying configurations including Stateful Inspection, Proxy based and Packet Filtering among others. Firewalls may be integrated within a web server or any other system components or may further reside as a separate entity.

The computers discussed herein may include a suitable website or other Internet-based graphical user interface which is accessible by users. Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like.

Computer program instructions may be loaded onto a general purpose computer, special purpose computer, or other programmable data processing apparatus to produce a machine, such that the instructions that execute on the computer or other programmable data processing apparatus create means for implementing the described functions and features. These computer program instructions may also be stored in a computer-readable memory that may direct a computer or other programmable data processing apparatus to function in a particular manner, such that the instructions stored in the computer-readable memory produce an article of manufacture including instruction means which implement the function specified in the flowchart blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus include steps for implementing the functions of the present invention.

Any steps or functions described herein may be implemented by either special purpose hardware-based computer systems that perform the specified functions or steps, or suitable combinations of special purpose hardware and computer instructions. Practitioners will appreciate that the steps described herein may include the use of windows, web pages, web forms, popup windows, prompts and the like. It should be further appreciated that multiple process steps may be combined into single steps or single steps may be separated into multiple steps for the sake of simplicity. Similarly, the steps described herein may be performed in any suitable order for a given application.

Any web pages described herein may include any number of features represented by different tabs, list item, links and the like, may be accessible from any number of interactive screens. Comments fields and standard menu or action links may likewise be cross-linked or associated with any displayed information, field, or other links. Entry of information in any of the described fields may be accompanied by a summary or confirmation page. In a web-based embodiment, the system may include conventional browser and file menu options such as find, browse, edit, format and view functions. Auto-completion may be enabled for certain fields and defaults for others may be preset or user defined. For example, the current date may be automatically entered in any date field, yet still provide for alteration by a user.

Tabs, icons, list items, menu items, radio buttons, etc. may be used interchangeably and may be fully customizable, for example, as to number, title, contents, cross-references, and the like. Screens, windows, and dialogue boxes may refresh upon completion of certain tasks, upon depressing a mouse button or enter key, or may simply refresh at preset time intervals. Any window, screen, or document may be exported, printed, emailed, or saved. Passwords may be required for access at any given system level or feature providing increased security or privacy. For example, available options, features, and links may be determined by administrative authorizations assigned to individual users. Encryption may also be used to increase security.

Although the present invention is described with respect to medical data management (e.g., patient records management), the invention is not so limited, and may be used to manage input and storage of any similar patient or client associated information and documentation. For example, the data input and administration systems described herein may be tailored to and associated with any number of existing office management applications in any industry or application in which personal information is required of the client or customer.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of the invention.

What is claimed is:

1. A medical data entry system, comprising:
an electronic patient information record;
a data entry system configured to populate said patient information record with information entered by a patient; and
an administration system interfacing with said data entry system and configured to format said information for use by a medical office management system.

2. The system of claim 1, wherein one of said data entry system, said administration system and said medical office management system is configured to verify said information in said patient information record.

3. The system of claim 1, wherein said data entry system interfaces with said administration system over a network.

4. The system of claim 1, wherein said administration system uses said patient information record to generate a document for execution by said patient.

5. The system of claim 4, wherein said document is one of a do-not-resuscitate request, medical procedure authorization, information disclosure authorization, health care power of attorney, and advanced medical directive.

6. The system of claim 1, wherein said patient information database includes a plurality of patient information records.

7. The system of claim 1, wherein said data entry system and said administration system are separate user computers in a medical office.

8. The system of claim 1, wherein said data entry system and said administration system are software modules accessible by a patient and an administrator respectively on a single computer.

9. The system of claim 1, wherein said data entry system is a webpage accessible by a patient over the Internet.

10. The system of claim 1, wherein said data entry system automatically populates said patient information record with information submitted by the patient in the form of one of a fax, email, scanned image, smartcard, magnetic stripe, and transponder.

11. A method of capturing patient data comprising the steps of:
requesting patient data from a patient via an electronic data entry system;
receiving said patient data via said electronic data entry system; and
accessing said received patient data through an electronic administration system.

12. The method of claim 11, further comprising storing said received patient data within a medical office management system.

13. The method of claim 11, further comprising automatically verifying one of the format and completeness of said received patient data.

14. The method of claim 11, wherein said electronic data entry system comprises a webpage.

15. The method of claim 11, wherein said receiving and said accessing are performed at separate terminals connected by a network.

16. The method of claim 11, wherein said receiving and said accessing are performed using separate software modules on a common terminal.

17. The method of claim 11, wherein receiving said patient information includes receiving information submitted by the patient in the form of one of a fax, email, scanned image, smartcard, magnetic stripe, and transponder.

18. The method of claim 11, further comprising generating a formal document for execution by said patient using said received patient data

19. The method of claim 18, wherein said formal document is one of a do-not-resuscitate request, medical procedure authorization, information disclosure authorization, health care power of attorney, and advanced medical directive.

20. A medical information input system configured to facilitate input of data to a medical office management system, the system comprising:
a data entry device separate from the management system,
an administration system; and
a patient information database, wherein said administration system is configured to verify said patient information for completeness and formatting, store said patient information in said patient information database, and format said patient information for use by an office management system.

21. A method of managing patient data for a medical office comprising the steps of:
providing a data entry system, in a medical office, that is accessible by patients and that is configured to receive patient information;
storing said patient information as an electronic patient information record in a patient information database; and
formatting said patient information for use by a medical office managements system.
